(19) United States
(12) Patent Application Publication
(10) Pub. No.: US 2008/0169939 A1
(43) Pub. Date: Jul. 17, 2008

(54) EARLY WARNING CONTROL SYSTEM FOR VEHICULAR CROSSING SAFETY

(76) Inventors: CHARLES E. DICKENS, Chesapeake, VA (US); Bob Wilson, Norfolk, VA (US)

Correspondence Address: Alexander D. Raring;Thomas & Raring, P.C., 536 Granite Avenue, Richmond, VA, 23226, US

(21) Appl. No.: 12/013,056

(22) Filed: Jan. 11, 2008

Related U.S. Application Data
(60) Provisional application No. 60/864,195, filed on Jan. 11, 2007.

(51) Int. Cl. G08G 7/02; G08G 1/017

(52) U.S. Cl. 340/910; 340/937

(57) ABSTRACT

A system for alerting drivers and maintenance personnel of approaching commercial vehicles at train or maritime crossings and for alerting train engineers and ship captains of obstructions in the crossing. The system includes video monitoring and the ability to transmit one or more video feeds by broadband directly to the operators of the commercial vehicle. The system also selectively ties into a broader network to record data, such as traffic counts at the crossing based on relative size of the counted vehicles, or video for review and processing. Maintenance personnel can electronically provide contact information to the system so that the personnel are alerted via cellular communications when a train is approaching the personnel's work area. Properly equipped vehicles will also receive and transmit alert broadcasts to the system to further increase safety and notification times.

This application claims priority to U.S. Provisional Application No. 60/864,195, filed Jan. 11, 2007, the contents of which are incorporated herein in its entirety.

The present invention is directed to vehicular crossing safety and rail maintenance system. More specifically, among other features, the railway or maritime crossing safety system of the present invention provides an early warning to pedestrians, motorists, and the like at a railway or maritime crossing. The system facilitates the exchange of data and/or video between a train/maritime crossing, a rail maintenance crew and an approaching commercial vehicle or central command location.

### BACKGROUND

The continuing safety concerns with railway and maritime road intersections are well documented. A recent well known case, referred to as the Fox River Grove level crossing accident, involved the death of seven students in Fox River Grove, Ill. In that incident, a passenger train traveling about 50 miles per hour struck the back of a school bus carrying high school students. In addition to the seven deaths, twenty-one students were injured including blunt trauma, skull fractures, lacerations and internal injuries.

The National Transportation Safety Board (NTSB) has developed an approximated time-line of the incident. It is thought that the approach of the train was not detected until 32 seconds before the impact, and the crossing system was not notified of the approaching train until 24 seconds before impact. The train engineer's only warning of an impending accident was their own visual reconnaissance of the crossing. A mere five seconds before striking the bus, the engineer activated the emergency braking system.

One of the identified causes of the accident was the crossing design. Magnetic sensors, which were connected to traffic signals, were only located on one side of the intersection. Obviously, activating the warning lights on the railroad crossing at about 20 seconds before the arrival of the train was insufficient.

The incident, which occurred late in 1995, brought further scrutiny and attention the safety of intersections between commercial vehicle traffic and public road traffic. Legal claims from the victims were not resolved until 2004. Additional legislation has been considered or introduced that would require the re-engineering of crossings to prevent similar accidents. Most of the solutions are piecemeal procedures to fix the particular circumstances of the Fox River Grove incident. A more comprehensive and proactive solution is needed that could uniformly upgrade crossing safety in multiple legal jurisdictions.

Various obstruction detection systems have been developed. However, these systems do not adequately provide an early warning to individuals who might in, or about to enter, a railway crossing In addition, among other shortcomings, the systems do not provide an early visual inspection option to the train engineer.

Rail and maritime crossing maintenance workers engage in potentially dangerous work given the potential injury of working with large commercial vehicles. There are reported incidents where maintenance personnel are unaware of an approaching vehicle and are, therefore, injured because there is not an automated mechanism for warning the personnel.

There is a need for a system to present a warning prior to the activation of traditional crossing guard arms. Ideally, such a system would include improvements such as, but not limited to, the capability to detect the presence and size of a vehicle stopped in a commercial crossing, the capability perform traffic counts by vehicle size, the ability to adapt the system to maritime commercial crossings, the capability to relay to a commercial vehicle (train or ship) crossing data and/or video, the capability to warn maintenance personnel of an approaching commercial vehicle, the ability to provide two-way audio, video or data between a central command unit and other commercial assets, and the capability to activate a crossing guard and warning system via broadband. The early warning control (EWC) system of the present invention provides one or more of the above improvements or otherwise overcomes the above or other shortcomings in the prior art.

### SUMMARY

The early warning control (EWC) system for commercial crossing safety of the present invention provides individuals additional warning time in which to clear a commercial crossing, such as a train or commercial maritime crossing. In one embodiment, the EWC system activates an early warning that is initiated prior to the activation of the pre-existing crossing guards or crossing signals. This early warning may be a voice announcement to signal the approach of the train. An optional secondary audio alarm provides staged warning indicators to pedestrians and motorists in addition to traditional crossing apparatus.

Sensors, such as infrared sensors, radar, or the like, would detect obstructions within the crossing. The obstruction detection would initiate a additional warnings and/or early warnings, as applicable. In addition, the sensors can work in conjunction with communication means to provide data/video to an approaching commercial vehicle or central command station. Optional secondary sensors are operable to detect the size of a vehicle moving over the crossing. Traffic count data and count data for specific size vehicles could then be generated and used to rank the priority and/or relative safety of a particular crossing. For example, crossings with relatively high percentages of bus or commercial tractor crossings could receive further safety scrutiny. The Fox River Grove crossing identified above would be one such crossing. There was no mechanism in place that was tied to the crossing safety system to count or rank the volume or size of traffic. Vehicles were routinely and unknowingly obstructing the tracks. The EWC system disclosed herein would adjust, or would lead to the adjustment of, the traffic timing signals for such problematic HRIs.

In another preferred embodiment, activation of the EWC system further engages a camera, media recorder, and/or a flood light assembly. It is envisioned that live video could be transmitted to a train engineer's monitor. In the event that the obstruction detection circuit determines that an obstruction existed on the tracks, a visual and/or audible alarm could also be sent to the approaching train's engineer. The optional media recorder would record the crossing for temporary or permanent storage. The flood light assembly would provide enhanced viewing in low light situations. Live video would provide a train engineer or ship's captain with additional information regarding a possible or imminent accident.

It is known to include track circuit sensors that detect broken or cut track rails. The EWC could include an additional feature of integrating pre-existing track circuit sensor output in order to transmit data to an approaching train's engineer. The video system above might also be activated in the event that the track sensor circuit determines there is a failure in the rail line. In another preferred embodiment, the EWC system include a fail-safe power supply so that some safety features (warnings, crossing guards, or the like) would still be activated in the event of a power failure.

Rail and maritime workers also face significant safety concerns as they are working with large and sometimes fast moving vehicles. As such, the EWC might also be integrated into a communication system that automatically informs assets such as vehicles or individuals within the range of a highway rail intersection (HRI) of an approaching commercial vehicle. Maintenance personnel would establish a safety perimeter. Cellular phone communication would notify the personnel so that they can clear the way for train/vehicle or clear the intersection/drawbridge before activation of the crossing/drawbridge apparatus. Vehicles could also be equipped to notify the EWC if they are disabled within the HRI. As such, an approaching commercial vehicle could be given an early warning that an intersection is not clear.

Other collected data from an HRI could include information for a quantitative preventative maintenance program. Namely, the number of times a crossing safety system is activated could be reported so that maintenance personnel could be dispatched relative to the use of the HRI. For example, warning bulbs might be replaced at set hours of use based on data reported through the EWC system of the subject invention. Maintenance schedules could be built and executed around expected failure rates as the EWC would report cumulative operating hours for any specific, monitored HRI. A central command center would act as a remote database to record video, data, and/or audio from the EWC system at a specific HRI.

It should be understood that the proposed EWC system is intended for use with rail crossings or maritime bride crossings. Therefore, references to ‘train’ or ‘rail crossings’ are intended to be interchangeable with ‘ship’ or ‘draw bridge’ crossings. Used in context, a commercial vehicle for the purposes of this application will mean either a train or ship. Commercial roadgoing vehicles include tractor trailers, commercially operated vans or trucks, or the like.

Overall, the existing technology does not permit one to move an alarm system “back in time.” That is, the EWC system will work in conjunction with pre-existing train detection sensors/switches, crossing safety devices, and rail maintenance monitoring systems. The EWC system can also operate warning devices independently or in the absence of a pre-existing crossing predictor safety system. However, it provides warnings and obstruction detection prior to the activation of a crossing guard or other pre-existing (i.e., pre-EWC system) apparatus. The EWC system incorporates with known or pre-installed systems to provide a comprehensive railway crossing system for safety. The ability to communicate data and video to a commercial vehicle or command center will increase safety. The EWC system could receive broadband communication from an approaching ship to bypass traditional detection mechanisms.

While the above highlights particular features of the invention in order that the detailed description thereof may be better understood, and in order that the present contribution to the art may be better appreciated, there are additional features of the invention that will be described hereinafter. Also, it is to be understood that the phraseology and terminology employed herein are for the purpose of the description and should not be regarded as limiting.

### BRIEF DESCRIPTION OF THE DRAWINGS

The foregoing, and additional objects, features, and advantages of the present invention will become apparent to those of skill in the art from the following detailed description of a preferred embodiment thereof, taken in conjunction with the accompanying drawings, in which:

FIG. 1 is a plan view of an embodiment of the early warning control system as disclosed herein;

FIG. 3 is a top-down view of the an embodiment of the present invention;

FIG. 3 is a view of an additional embodiment of the present invention;

FIG. 4 is a side view of one embodiment of the EWC system disclosed herein;

FIG. 5 is a block diagram of the EWC system of the present invention integrated with pre-existing railway crossing apparatus in accordance with one embodiment of the present invention;

FIG. 6 is an example of a video image generated by the EWC system as disclosed herein;

FIG. 7 is another example of the same;

FIG. 8 is a schematic illustrating the use of the EWC system with sequential HRIs; and

FIG. 9 is an example of video images generated by the EWC system for use with sequential HRIs.

### DETAILED DESCRIPTION

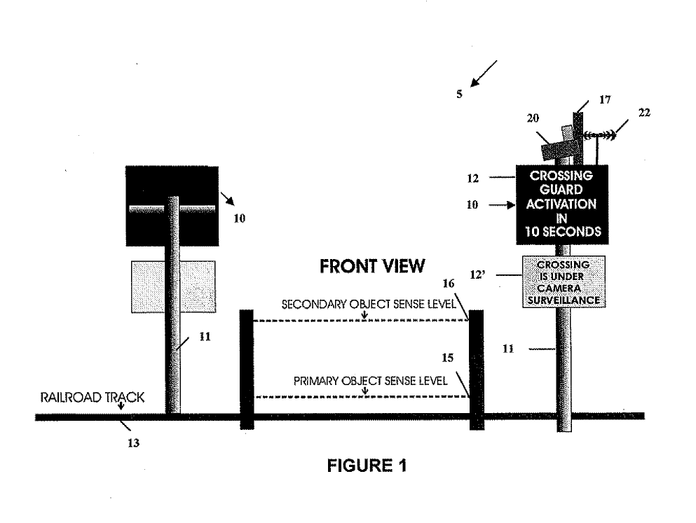

Turning now to a more detailed description of the present invention, there is illustrated in FIGS. 1-9 embodiments of the EWC system disclosed herein. Features of the present invention, including the assembly, construction, or installation of the EWC system, in general, will not be described in extensive detail inasmuch as such details are known to those with experience in crossing safety devices and/or would be obvious in light of the teaching below. Moreover, the illustrated embodiments are merely exemplary. The present invention need not be associated with one of the illustrated embodiments as it is adaptable for operation with a wide variety of existing railway crossing devices or maritime applications.

The attached figures are alternative examples of the EWC system in accordance with the present invention. Of course, other variations and configurations of the present invention might be developed in conjunction with one or more of the features of the present invention without deviating from the scope of the claims as defined below.

In general, the EWC system improves upon current crossing systems and apparatus. Moreover, the EWC provides, in one embodiment, a database to the rail industry for the development of a quantitative preventative maintenance program that should greatly reduce the emergency maintenance requirements that exist currently. The number of personnel needed for the technical support of an HRI should decrease. The subject system also provides an additional revenue stream opportunity to the rail industry from the sale or lease of data collected by the EWC system at vehicular rail crossings.

In further detail, with reference to FIG. 1, individual EWC units of the larger EWC system are contained within a control box 10, which houses the electronics and circuits controlling a EWC unit of the EWC system 5 of the present invention, or in an independent housing assembly (see FIG. 2). Box 10 or the independent housing assembly may also house existing infrastructure, such as traditional warning predictor switches and crossing guard arm controls. The operating system of the EWC system is designed to plug into and interface with the current or existing infrastructure in place at vehicular rail and maritime crossings, if applicable, as would be understood by one of skill in the art. Otherwise, the EWC could operate in the absence of an existing grade crossing predictor commonly in use at HRIs. The ability to dovetail the EWC system operating system with existing grade or maritime crossing predictor apparatus greatly reduces installation costs. Basically, the entire EWC system can effectively ‘plug into’, and be housed with, pre-existing infrastructure, as needed. The EWC system provides an updated and improved control foundation upon which different modules can be installed so that a combination of EWC system options can be enabled at the crossing on demand.

A central command center or central command control (CCC) (not illustrated) is electronically connected to the individual EWC unit installations by wired or wireless means known to one of skill in the art. For example, in one preferred embodiment, the connection of the EWC unit to the CCC will comprise a wired, broadband connection. The EWC unit could also communicate with the CCC by wireless broadband or other known communication standard(s). System options for individual EWC installations can be physically installed or could include remote software enabling from the CCC. As such, a rail crossing administrator may employ or disable a number of envisioned safety features of the EWC system, as described further below, for a particular vehicular crossing. These features may be updated as needed.

The optional connection to a CCC also allows a rail traffic control center, which is operable to monitor, control and view rail traffic, to access a database (not illustrated) associated with the EWC system to retrieve HRI information or to make any operational adjustments. Information provided by an EWC unit can dictate the operational standards a particular HRI. For instance, if a defect in the crossing predictor unit is reported, the rail traffic control center may lower the operational speed of a train approaching the particular HRI to increase safety and to prevent accidents and downtime.

Box 10 would also include or control displays 12, 12′, which may display permanent or temporary messages. One or both displays would be electronic (e.g., the displays consist of LED lettering) and at least one display is controlled by the EWC system. A crossing post 11, corresponds to and supports each box 10 and displays 12, 12′. Posts 11 are located to each side of a railroad track 13 crossing.

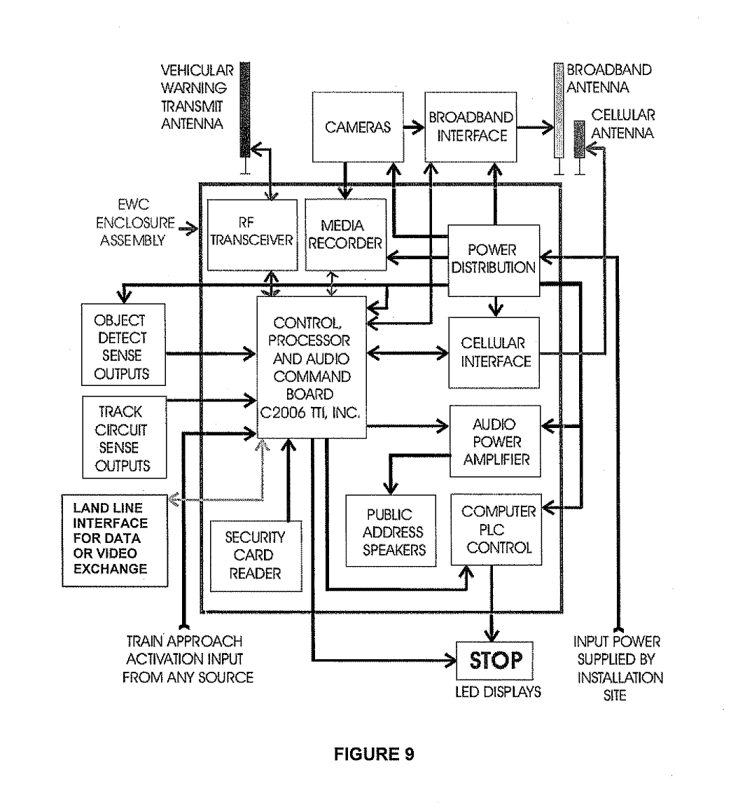

A plurality of sensors, preferably infrared sensors, will detect the presence of an object in the crossing. It is envisioned that sensors 15 might also employ lasers, radar, or the like to detect objects in a rail crossing. Where and when an object is detected, the sensors will communicate the presence of an object to the EWC unit (and the unit's control processor, as described below; see FIG. 9) in box 10 for further action. A primary object sensor 15 is provided at a level to detect humans or any vehicles intersecting the line of sight of the sensor. These sensors are known in the art. An optional secondary object sensor 16, however, could be provided at a height or position that would be operable to deduce at least the relative sizes of the object(s) in the crossing. By this means, the object sensors 15, 16 could be used to record the presence of particularly large vehicles in the crossing. The sensors can provide constant data to the EWC database, the data could be continuously recorded in a media recorder associated with the EWC unit, and/or the sensors may only be activated when an approaching train is predicted. In the latter case, the secondary sensors would convey the relative threat of a vehicle in the crossing. Under either approach, monitoring via the primary and secondary sensors would provide vehicle counts based on relative vehicle size. This information would be useful to the railway owner in order to rank the importance and safety risks presented by specific HRIs. Logically, the relatively high use of a crossing by larger vehicles would increase safety and property damage risks relative to crossings with relatively low use by larger vehicles.

Once aspect of the EWC system is the ability to retrofit or build road-going vehicles compatible to receive and process signals from or transmit information to the EWC units. A properly equipped vehicle includes a broadcast unit (not illustrated) to send and receive EWC transmissions. The broadcast EWC alert from the EWC unit to vehicle's broadcast unit would override the vehicle's radio receiver and/or activate the radio system as needed.

The first broadcast alert is generated when the EWC unit predicts a train is approaching the crossing. The vehicle's radio or media control center would then reproduce the audible alert to warn motorists or maintenance personnel of the approaching train. In another embodiment, a properly equipped vehicle could receive the transmission to create a visual alert, such as a flashing warning indicator within the vehicle's dash module. The timing for turning on and off the alert broadcast could be modified as needed. The alert could also be manually cancelled by the vehicle owner/operator. It is envisioned that voluntary or regulatory-mandated use of the EWC-equipped vehicles would at least begin with commercial and governmental road-going vehicles such as commercial long-haul tractor trailers, commercial buses, school buses, and the like.

Such an EWC system-compatible vehicle provides additional safety benefits. Where such a vehicle could be disabled inside the ‘sense’ zone of the crossing, the operator could selectively activate an emergency indicator. For example, activating the emergency/hazard lights could simultaneously activate an EWC broadcast from the broadcast unit to the EWC unit. This alert EWC broadcast could also be engaged through an independent switch or button installed in the vehicle that is electronically connected to the vehicle's broadcast unit. In any event, the EWC unit would receive the alert broadcast via an antenna and RF transceiver connected o a control processor (see FIG. 9). The control processor would rebroadcast the distress signal generated by the vehicle to the CCC or directly to an approaching train(s) engineer, preferably via broadband communication provided by a broadband interface and antenna. The distress broadcast could include associated information regarding the purpose or size of the particular vehicle. This information regarding the disabled vehicle would then be displayed at the CCC or on an monitor (discussed further below) visible to the train engineer.

Multiple antennas are be associated with the EWC unit to enable the broadcast and receive capabilities of the EWC system. A vehicular warning transmitter/receiver antenna 17 on box 10 is operable in conjunction with an RF transceiver, as discussed above, to broadcast or receive the alert transmissions between vehicles and the EWC unit. Box 10 can also include a camera 20 and broadband antenna 22, both of which will be discussed further below.

Turning now to FIG. 2, an independent EWC housing assembly 24 is illustrated where housing assembly 24 is located with the existing crossing predictor. In this top down illustration of one embodiment of the subject EWC system, a roadway rail crossing intersection is clearly indicated. Currently, as a train approaches an HRI, it physically trips crossing shunts. This action activates an existing crossing predictor. The predictor begins a preset countdown at the conclusion of which crossing arms 23 are lowered to prevent traffic from crossing railroad track 13. Activation of the crossing arm motors or crossing warning lights is generally set to 30 seconds before the train reaches the crossing.

The EWC system provides additional warning to motorists by immediately activating audible and/or visual (via displays 12 or 12′) warnings of the approaching train. In other words, the EWC unit operates independently of the existing crossing predictor countdown in order to provide additional warning time to motorists as the operation of the EWC system provides a warning prior to the activation of existing systems. The unit predicts and anticipates the approach of a commercial vehicle to the crossing. The plurality of infrared sensors 15 provide lines-of-sight that are interrupted by the presence of a vehicle. When an approaching train is detected, the interrupted line of sight triggers an alarm to the EWC unit 24. The object detect alarm causes the EWC unit to activate additional audio or visual alarms. These secondary warnings notify the motorist that they are obstructing the tracks.

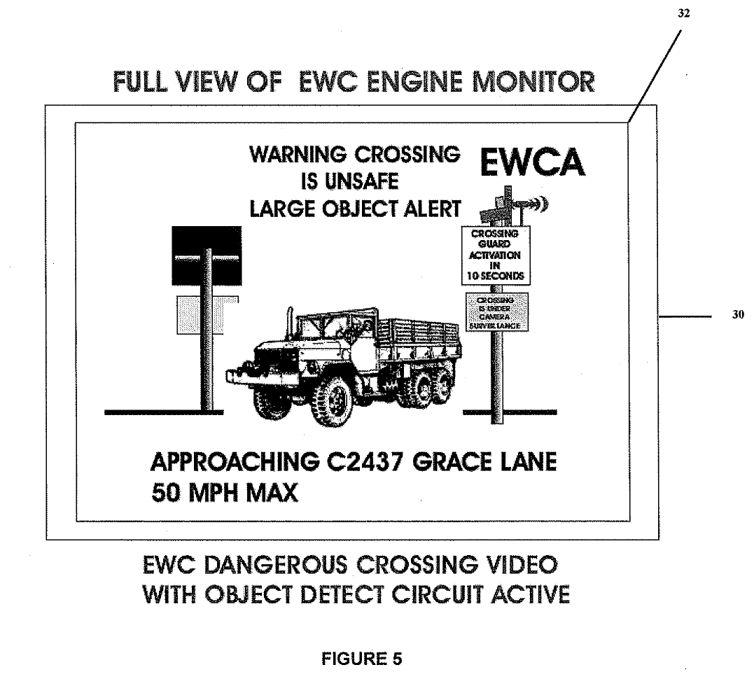

In addition, the object detect alarm could selectively engage camera 20 and optional camera 21. This camera(s) is operable to monitor the railway crossing associated with the EWC system. Video from the camera(s) can be recorded and/or broadcast to either the CCC or approaching train engineer. The broadcast of a video signal is discussed further below. An optional media recorder (see FIG. 5) could use tape, DVD, flash memory, or the like when the object detect alarm is active.

An optional feature of the EWC system enables the activation control to be independent of the existing crossing shunts or the presence of a grade crossing predictor at an HRI. Specifically, the entire EWC unit could be activated by using a wireless predictor option. A two-way failsafe object detect circuit would be located on each approach end to an HRI. Wireless sense circuits are used in place of typical shunt detectors. Upon detection of a locomotive, the activation control would be transmitted via wireless broadband to the EWC. The train approach wireless sense circuits broadcast would be received by broadband antenna 22. A secondary broadband antenna 22′ is electronically connected to the wireless sense detect components.

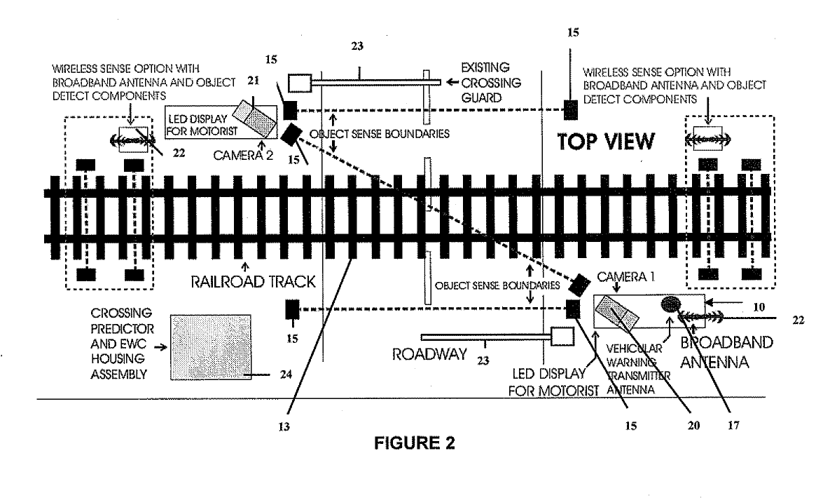

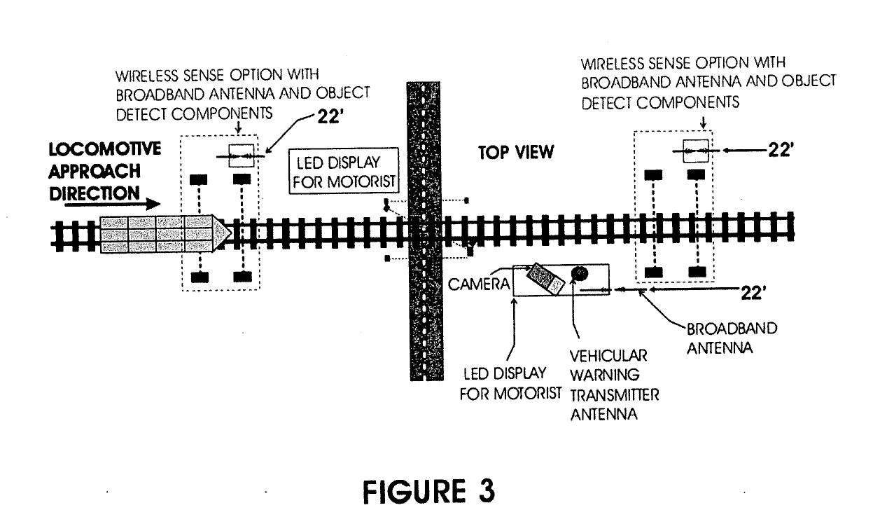

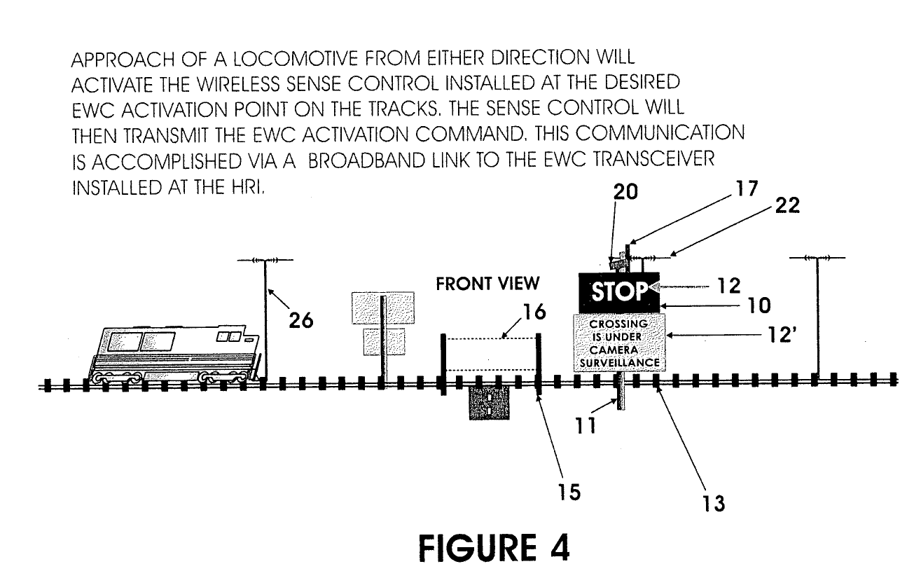

This wireless sense option with broadband antenna and object detect components is further illustrated in FIG. 3. The object detect components can be any known sensor mechanism, including infrared, radar, laser, or the like. In yet another embodiment, which is illustrated in FIG. 4, a broadband or other type engine transmitter 26 is located on each train engine. As the engine approaches an HRI, the transmitter automatically signals the approach of the train to the EWC unit thereby activating each of the installed EWC unit safety components. The engine transmitter signal can be received by one or more of the antennas 17, 22 provided on box 10. In other words, the activation of the crossing alerts and predictor will be accomplished by the use of either the sense control or EWC-equipped locomotive. The sense control is a physical object detect mechanism such as a switch or radar, infrared, or magnetic sensors. The EWC-equipped locomotive communicate with the EWC unit as it approaches the HRI to identify the approach direction, time to the HRI, speed, or other relevant information.

Once the base EWC unit is installed, different EWC modules (either physical components or software programs) can be added to the EWC operating system. It is envisioned that in one embodiment, trains operating in conjunction with the EWC system will have video monitors installed that would visually present video feeds, alarms, or other data to a train engineer of an approaching train. With reference to FIG. 5, there is illustrated a video monitor projecting a representative video image. The image is illustrated for the purposes of this description, but would comprise a video feed in use. A monitor 30 provides a video feed 32 received from an EWC camera 20, 21. The monitor will displace crossing information by name and/or number. The procedure for approaching the crossing, such as the speed limit, as set by the rail control center is displayed on the video feed. All this information has been uploaded to the specific EWC unit for the respective crossing.

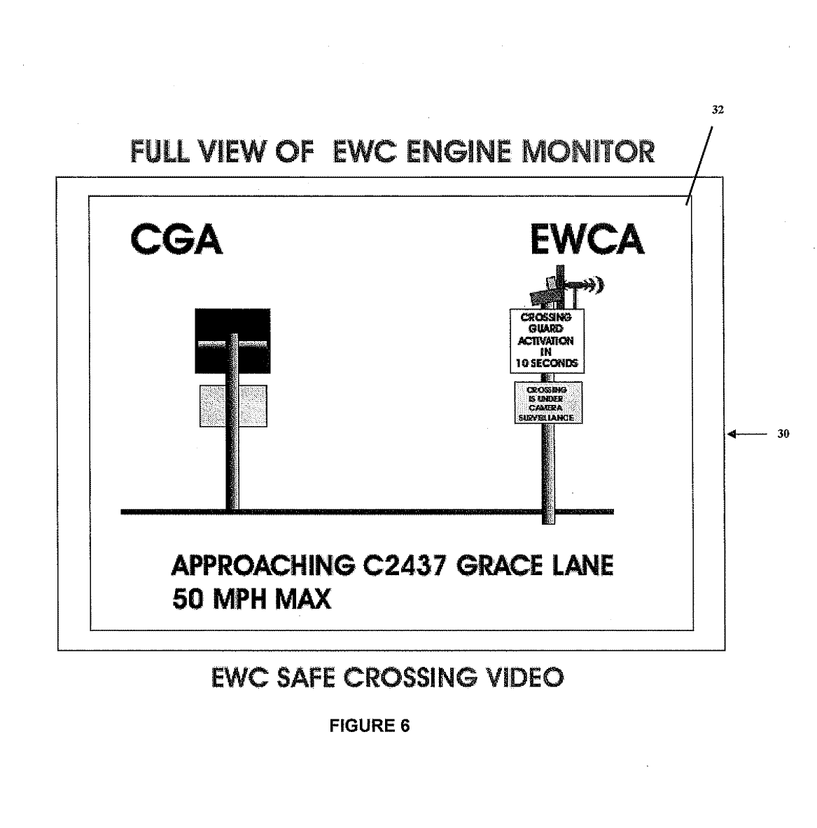

Monitor 30 can provide real-time video information to the engineer until the engine reaches or passes the crossing (see also, for example, FIG. 6). Alternatively, video feed 32 may be activated only when the object detect sensors 15, 16 located at the crossing detect the presence of an obstruction. Voice communication by known means to the engineer from the CCC, if the EWC system is so equipped, is also envisioned.

Existing track loop sensors, used to detect the presence of a rail failure over a given stretch of railroad track, can signal such a failure to the EWC. This failure is reported by the EWC unit to an approaching train or to a CCC. In the event that the approaching train includes monitor 30, such an alarm could also be displayed to the engineer. Still other information, such as maintenance schedules (see FIG. 6), could be visually depicted via monitor 30 in an approaching train engine. Return communication from the engine to the EWC is permitted so that the train engineer might flag an observed maintenance issue by engaging a physical switch or touch-sensitive button on the monitor. The maintenance flag is date and time stamped and reported by the EWC to the relevant maintenance personnel.

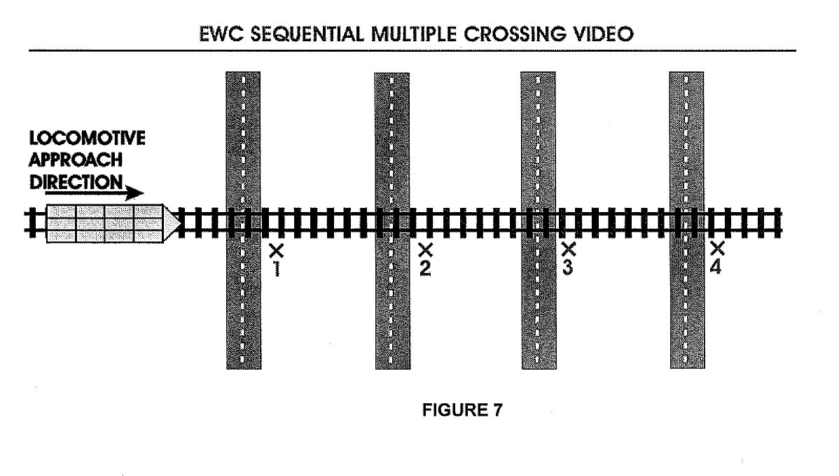

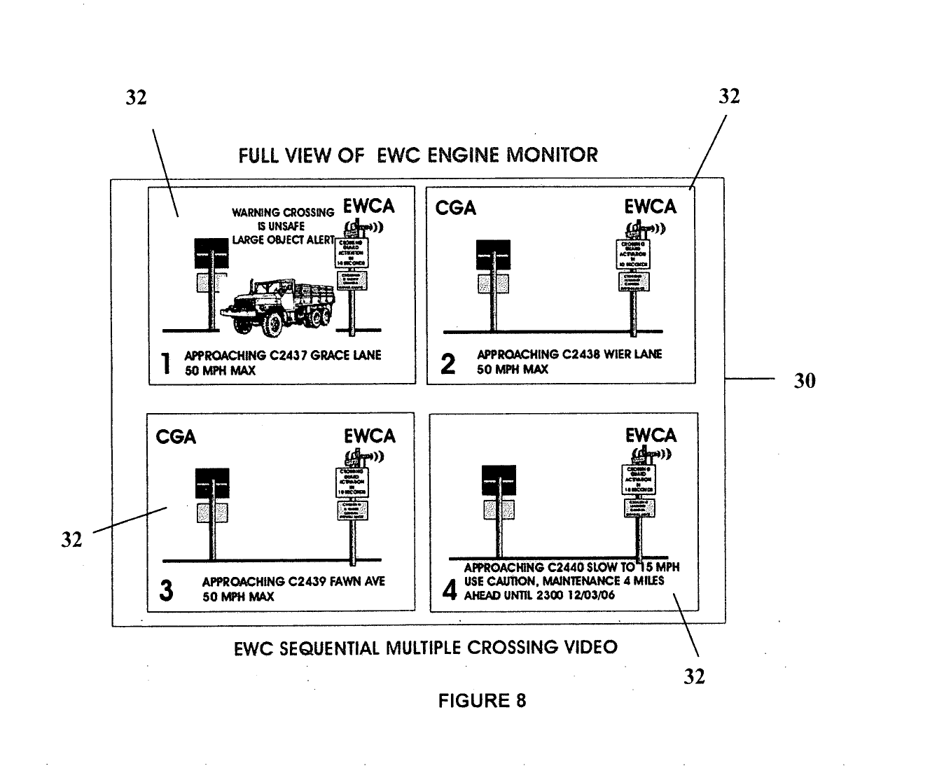

It is often the case than a locomotive will approach several closely spaced crossings, as illustrated in FIG. 7. The EWC system automatically sorts video and data for multiple crossings that are interlinked via a DAX module or are wirelessly linked to the EWC system. Crossing condition data is displayed on the engineer's video display as before (see FIG. 8). In addition, the multiple video feeds received from the sequential EWC units at the plurality of crossings are tagged so that monitor 30 displays the video feeds in order of the first crossing to the last crossing. FIG. 8 presents an illustration of multiple sorted feeds, as described above.

As noted above, the rail industry works to ensure the safety of maintenance personnel who arc engaged in maintenance that a train is approaching. Heretofore, there has not been an effective automated system. In accordance with one embodiment of the present invention, before track maintenance is initiated, maintenance personnel can establish a safety perimeter by indicating to a particular EWC unit that personnel will be working in the vicinity of the EWC unit. This can be accomplished via known input means, such as a keyboard, mouse, toggle switch or the like. In one envisioned embodiment, personnel would use a card reader associated with the EWC unit to process an identification (ID) card. The card reader reads data on the ID card, including cellular contact information for that personnel, if applicable. Regardless of the mechanism used, the maintenance personnel effectively ‘log in’ to the EWC unit or system. The EWC unit or system will then notify the personnel when a train is approaching.

By scanning the ID card, the personnel's presence and/or work itinerary is entered into the EWC system for later retrieval from the media recorder or logging, as necessary or desired. Maintenance schedules can be automatically updated with this data. More importantly, the EWC unit and system communicate with the personnel when a train is approaching the area into which the service personnel are logged in. This effectively creates an electronic safety service perimeter. Communication from the EWC system to the maintenance personnel be accomplished in a number of ways. For instance, any rail service vehicle that has a EWC communications display installed will also have visual access to the HRI information that a train engineer is provided.

It is also envisioned that voice communication from the optional CCC would be available to rail personnel as well. Basically, events and data reported by the EWC unit to the CCC or larger EWC system network can be relayed to the maintenance personnel, the presence of which at the HRI would be known by the personnel logging into the EWC unit. Broadband communication from the unit directly to the personnel or service vehicles in envisioned.

It further detail, in one embodiment of the EWC system, once the EWC unit predicts a train is approaching, it broadcasts a warning alert via a cellular interface and cellular antenna to cellular receivers associated with maintenance personnel in the area. The maintenance personnel first provide the appropriate cellular receiver information to the EWC unit via the card reader, as above. Cellular communication could include a voice alert, warning tone, or text message alerting the personnel of the approaching vehicle. The card reader can be engaged again in order to log out the maintenance personnel when work is complete. The EWC unit would include a timing mechanism to automatically log out personnel after a set period of time.

The EWC system provides a test switch (not illustrated) inside control box 10 that enable maintenance or regulatory personnel to simulate a train crossing. The functionality of the system can be examined during the simulation. The EWC also includes a two-way fail safe mode. Should the EWC fail or lose power, the crossing guards (if included) will still operate. Should the crossing guards fail instead, the EWC would still display the electronics messages and broadcast the verbal warnings/commands.

The operation of the EWC system is further illustrated in the flow chart of FIG. 9. A preexisting power supply supplies energy to an AC power distribution circuit. The media recorder, such as a DVD recorder or hard drive, camera(s), broadband interface, audio power amplifier, electronic displays, cellular interface, and obstruction detection sensors are connected to the AC power distribution circuit. Each of the installed modules or components are electronically connected to the control processor. As such, the media recorder can capture all data and events communicated to or from the control processor.

The AC power distribution circuit also supplies energy to a an EWC control processor and audio command board. The control processor accepts input from external switches or sensors such as a train approach activation switch, track circuit sensors, or other preexisting devices installed prior to the EWC by the railway company. In place or in addition to the physical train approach activation input, the activation input can be a wireless signal from the train engine, as described above.

When the train approach switch is actuated, the EWC is activated to receive input from the track circuit sensor and obstruction detection system. The first output from the control processor activates the electronic displays and sends a signal through the audio power amplifier. The first output signal is then amplified and sent to public address speakers. At the proper time interval, and following the first output, the control processor engages the crossing guard motor or other traffic control measures (traffic signal lights).

In one preferred embodiment, in the event that the obstruction detection system or track circuit sensors determine there is an obstruction or failure with the railway, the control processor engages the broad band interface, camera(s), and media recorder. The video feed(s) is then broadcast via the antenna, such as a broadband antenna, to the train engine, as discussed above. An alarm or warning may also be broadcast to alert the train engineer. Furthermore, when the obstruction detection system determines an obstruction exists in the railway crossing, the control processor will generate a secondary electronic message and secondary audio signal to issue a secondary warning at the crossing.

A vehicular warning transmit antenna also transmits and receives broadcasts to and from EWC-equipped vehicles. As described above, the operator of an EWC-equipped vehicle could indicate the vehicle is disabled or in distress by activating the EWC component installed in the vehicle. The EWC component in the EWC-equipped vehicle is a broadcast unit compatible with the warning antenna and RE (radio frequency) transceiver of the EWC unit. The broadcast unit (not illustrated), as would be understood by one of skill in the art, would broadcast a warning alert to the EWC unit if the EWC-equipped vehicle is in the crossing zone (i.e. the vehicle is in the crossing or immediately adjacent to the crossing). This broadcast is passed through an RF transceiver to the control processor. The processor would then relay the distress signal to an approaching train, if applicable, or to maintenance personnel via the broadband antenna or a cellular antenna. The applicable broadband interface or cellular interfaces are provided, as would be understood by one of skill in the art.

The vehicular warning transmit antenna is also operable to broadcast a warning from the control processor. The warning is passed through the RF transceiver and is sent via the antenna to EWC-equipped vehicle. Maintenance personnel, tractor trailer drivers, or any EWC-equipped vehicle operator would be alerted to the presence of an approaching train. EWC-equipped governmental vehicles, such as the school bus at the Fox River Grove crossing incident, would be notified even when the vehicle is stopped on the tracks and may not be able to see or hear the standard EWC system warning alerts (i.e. the alerts indicated by the LED/electronic displays or public address speakers).

Output from the control processor via a land line interface such as a broadband fiber optical cable or other broadband or standard transmission cable provides data to an EWC database or CCC. Communication from the HRI to the CCC can also occur via wireless broadband or cellular interconnect. In one scenario, the object detect sensor outputs are continually updated to the control processor. Secondary sensors can be used to record the passage of relatively large vehicles, as discussed above. Sensor data from either the primary, secondary, or both sensor is transmitted via the land line to the database for analysis. Therefore, traffic counts and, optionally, traffic counts by size can be recorded. The land line also provides the means to transmit instruction uploads and data from a rail control or EWC system administrator.

Any HRI that has the foundation of the EWC system installed can be configured to a crossing administrator or rail traffic administrator for site data collection. In addition to the traffic counts that are sortable by time and vehicle size, maintenance data or other data can be transmitted to a remote location/database and/or stored on the media recorder for retrieval by rail personnel. With the CCC feature installed, information produced at the EWC unit can be retrieved immediately or at st intervals. Aggregated data can be used to coordinate traffic timing or route planning. As such, the data can be offered for sale or lease to state, local or federal authorities, as applicable. In aggregate, the crossing activation data collected at an HRI can be used to build a database for a quantitative preventative maintenance program for monitored crossings.

All the data can be linked through the optional CCC. The CCC collects, maintains, and makes available the data in real time. This would allow EWC system adjustments or data input to be performed from a remote point either manually or automatically. For instance, daily traffic adjustments might be required for at pre-determined time each day. The CCC could communicate with the EWC unit to in act the traffic adjustments. In addition, the CCC system would provide system wide access to the entirety of the EWC units. As such, emergency and community data can be instantly taken into account. Evacuation orders, Amber alerts, advertisements, or other information can be shared across the EWC system.

Any maritime bridge crossing that currently employs a manual or automatic bridge lift controller can be configured for EWC system activation as well, including the audible/visual warning features and video surveillance. As with rail-based EWC units, a library of alternate warning alerts, warning timing adjustments, volume control adjustments, and the like could be employed. The EWC system is thought to be interchangeable between maritime and rail-based applications.

In conclusion, the sequence of events for the base-EWC system is as follows:

1) A short alert tone followed by a voice announcement that warns of an approaching train. 20 seconds later (30 second until train arrival) the pre-existing crossing guards, if included, will begin to lower. The tone and voice announcement continue to cycle. This provides a 50 second warning to motorists or pedestrians. The total time limit may be limited by the placement of the train sensor or the relative speed of the train. However, the EWC system is activated prior to the existing traffic control apparatus.

2) Upon activation of the system and until the EWC system is deactivated, the obstruction detection system determines whether an obstruction is present in the crossing. If an obstruction is detected, a new and louder tone and voice announcement follow. The voice announcement directs any person or object in the crossing to clear the track. This continues until the track is clear or the train has passed.

3) The initial activation of the system also initiates an electronic message at the displays flanking the railway. The electronic displays deliver a message to the driver regarding the approaching train and to proceed with caution once the train has passed.

4) The EWC system activation also activates the camera, media recorder (such as a DVD recorder), and flood light assembly, if included. Live video is transmitted to the approaching train's engineer.

5) A track circuit sensor monitors the railway via known techniques. The EWC incorporates the output of the sensor and will, if appropriate, provide an alarm to the approaching train's engineer.

6) The alarms and/or video generated by the obstruction detection system, the video camera, or track circuit sensor are transmitted to the train engineer. When applicable, multiple video feeds from sequential crossings are sorted and displayed on the engineers monitor in order of the distance from the train to the nearest crossing. The EWC system could optionally include an alarm acknowledgment. The engineer would be required to acknowledge the alarm either through a voice command registered by voice activation software, a manual act, or the like. The acknowledgment can be recorded in memory (not illustrated) either in the engine of the train or via a two way broadcast link to the EWC system.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. An early warning control (EWC) system for train and maritime crossings, the system comprising:
an EWC unit connected to the EWC system, the EWC unit comprising a control processor to accept sensor input and to generate commands, the control processor operable to predict the approach of a commercial vehicle and to produce commands upon the approach of commercial vehicle to the crossing;
a first alert tone and first voice announcement broadcast by the EWC unit in response to a first command produced by the control processor;
obstruction detection sensors to monitor a crossing, the obstruction detection sensors electronically connected to and activated by the EWC unit in response to a second command produced by the control processor, the obstruction detection sensors operable to detect an obstruction in the crossing and to communicate the presence of an obstruction to the EWC unit;
a second alert tone and second voice announcement broadcast by the EWC unit in response to a third command following the detection of an obstruction by the obstruction detection sensors;
a first electronic message displayed to individuals approaching the crossing via a roadway, the electronic message generated in response to a fourth command generated by the control processor, the first electronic message indicating to individuals the approach of a commercial vehicle to the crossing;
a camera electronically connected to the control processor and selectively providing a video feed to the control processor;
a broadband antenna electronically connected to the control processor and the camera; and
wherein the video feed is relayed to an approaching commercial vehicle via the broadband antenna, the video feed received by the commercial vehicle and displayed via a video monitor to one or more operators of the commercial vehicle.

2. The EWC system of claim 1, further comprising a media recorder electronically connected to the camera, the media recorder recording the video feed produced by the camera.

3. The EWC system of claim 1, further comprising a plurality of cameras monitoring a plurality of crossings, the EWC system sorting the video feeds produced by the plurality of cameras and displaying the video feeds via the monitor in order of the first crossing to be reached by the commercial vehicle to the furthest crossing to reached by the commercial vehicle.

4. The EWC system of claim 1, further comprising a broadband land line linking an EWC unit to the EWC system, the land line operable to transmit data and video from the EWC unit to the EWC system and to transmit data from the EWC system to the EWC unit.

5. An early warning control (EWC) system for train and maritime crossings, the system comprising:
an EWC unit installed at a crossing, the EWC unit comprising a vehicular warning antenna, a RF transceiver, and a control processor, the control processor operable to accept sensor input, to broadcast alert signals via the RF transceiver and antenna, and to receive broadcast alert signals via the RF transceiver and antenna, the control processor further operable to anticipate and predict the approach of commercial vehicle to the crossing;
an EWC-equipped vehicle comprising a broadcast unit operable to send and receive alert signals from and to the EWC control processor;
a first alert signal generated by the control processor to be broadcast to the EWC-equipped vehicle, the first alert signal received by the EWC-equipped vehicle, the first alert signal generated in response to the approach of a commercial vehicle to the crossing;
a second alert signal generated by the broadcast unit of the EWC-equipped vehicle, the second alert signal received by the control processor, the second alert signal selectively engaged by an occupant of the EWC-equipped vehicle; and
wherein the control processor generates a third alert signal, the third alert signal being generated in response to the received the second alert signal, the third alert signal being broadcast to commercial vehicles approaching the crossing.

6. The EWC system of claim 5, further comprising a camera and a media recorder electronically connected to the camera, the media recorder recording the video feed produced by the camera, the camera further electronically connected to a broadband interface, a broadband antenna and the control processor; and
wherein the control process selectively engages the camera and media recorder in response to the approach of a commercial vehicle.

7. The EWC system of claim 5, further comprising a broadband land line linking the EWC unit to the EWC system, the land line operable to transmit data and video from the EWC unit to the EWC system and to transmit data from the EWC system to the EWC unit.

8. The EWC system of claim 5, further comprising object detection sensors providing object detect sense outputs, the sense outputs received by the control processor.

9. An early warning control (EWC) system for train and maritime crossings, the system comprising:
an EWC unit connected to the EWC system via a land line interface, the EWC unit comprising a control processor to accept sensor input and to generate commands, the control processor operable to predict the approach of a commercial vehicle and to produce commands upon the approach of commercial vehicle to the crossing;
obstruction detection sensors to selectively monitor a crossing, the obstruction detection sensors electronically connected to the EWC unit, the obstruction detection sensors operable to detect an object in the crossing and to communicate the presence of the object to the EWC unit via object detect sense outputs, the sensors further operable to detect the relative size of the detected object;
wherein the control processor relays the object detect sense outputs via the land line to the EWC system, the EWC system receiving the sense outputs to provide vehicle counts by relative size of the detected vehicles.

10. The EWC system of claim 9, further comprising a media recorder electronically connected to the control processor, the media recorder selectively recording the object sense outputs produced by the object detection sensors.

11. The EWC system of claim 10, further comprising a camera electronically connected to control processor and to the media recorder, the camera selectively providing a video feed to the media recorder and control processor; and
wherein the vide feed is relayed to the EWC system via the land line.

12. The EWC system of claim 10, further comprising a camera electronically connected to the control processor and to a broadband antenna via a broadband interface, the camera selectively providing a video feed to the broadband antenna and the control processor; and
wherein the video feed is relayed to an approaching commercial vehicle via the broadband antenna, the video feed received by the commercial vehicle and displayed via a video monitor to one or more operators of the commercial vehicle.

13. The EWC system of claim 12, further comprising a plurality of cameras monitoring a plurality of crossings, the EWC system sorting the video feeds produced by the plurality of cameras and displaying the video feeds in order of the first crossing to be reached by the commercial vehicle to the furthest crossing to reached by the commercial vehicle.

14. The EWC system of claim 9, further comprising:
a vehicular warning antenna and a RF transceiver electronically connected to the control processor, the control processor operable to accept sensor input, to broadcast alert signals via the RF transceiver and antenna, and to receive broadcast alert signals via the RF transceiver and antenna;
an EWC-equipped vehicle comprising a broadcast unit operable to send and receive alert signals from and to the EWC control processor;
a first alert signal generated by the control processor to be broadcast to the EWC-equipped vehicle, the first alert signal received by the EWC-equipped vehicle, the first alert signal generated in response to the approach of a commercial vehicle to the crossing;
a second alert signal generated by the broadcast unit of the EWC-equipped vehicle, the second alert signal received by the control processor, the second alert signal generated engaged by an occupant of the EWC-equipped vehicle; and
wherein the control processor generates a third alert signal, the third alert signal being generated in response to the received the second alert signal, the third alert signal being broadcast to commercial vehicles approaching the crossing.

15. The EWC system of claim 14, further comprising object detection sensors providing object detect sense outputs, the sense outputs received by the control processor.

16. An early warning control (EWC) system for train and maritime crossings, the system comprising:
an EWC unit connected to the EWC system, the EWC unit comprising a control processor to accept sensor input and to generate commands, the control processor operable to predict and anticipate the approach of a commercial vehicle and to produce commands and broadcast alerts upon the approach of commercial vehicle to the crossing;
an antenna electronically connected to the control processor; and
wherein the control processor broadcasts a warning alert to maintenance personnel via the antenna, the warning alert broadcast in response to the approach of a commercial vehicle.

17. The EWC system of claim 16, the EWC unit further comprising a card reader electronically connected to the control processor, the card reader operable to read data on a security identification (ID) card provided by maintenance personnel.

18. The EWC system of claim 17, wherein the ID card data provides cellular receiver information associated with the maintenance personnel to the control processor.

19. The EWC system of claim 18, wherein the antenna comprises a cellular antenna electronically connected to the control processor via a cellular interface, the broadcast warning alert being transmitted to at least one cellular receiver in accordance with the cellular receiver information provided by the ID card.

20. The EWC system of claim 16, the EWC unit further comprising a broadband land line linking the control processor to the EWC system, the land line operable to transmit data read from the ID card from the control processor to the EWC system and to transmit data from the EWC system to the EWC unit.

21. The EWC system of claim 16, wherein the antenna comprises a vehicular warning antenna electronically connected to the control processor via a RF transceiver, the broadcast warning alert being transmitted to at least one maintenance vehicle proximate to the crossing.

22. The EWC system of claim 16, wherein the antenna comprises a broadband antenna electronically connected to the control process via a broadband interface, the broadcast warning alert being transmitted to at least one maintenance vehicle proximate to the crossing.

23. The EWC system of claim 16, the EWC unit further comprising a RF transceiver and a RF antenna, the control processor operable to receive broadcast alert signals via the RF transceiver and RF antenna;
an EWC-equipped vehicle comprising a broadcast unit operable to send and receive alert signals from and to the EWC control processor;
a first alert signal generated by the control processor to be broadcast to the EWC-equipped vehicle, the first alert signal received by the EWC-equipped vehicle, the first alert signal generated in response to the approach of a commercial vehicle to the crossing;
a second alert signal generated by the broadcast unit of the EWC-equipped vehicle, the second alert signal received by the control processor, the second alert signal generated engaged by an occupant of the EWC-equipped vehicle; and
wherein the control processor generates a third alert signal, the third alert signal being generated in response to the received the second alert signal, the third alert signal being broadcast to commercial vehicles approaching the crossing.

24. The EWC system of claim 24, further comprising a camera and a media recorder electronically connected to the camera, the media recorder recording the video feed produced by the camera, the camera further electronically connected to a broadband interface, a broadband antenna and the control processor; and
wherein the control processor selectively engages the camera and media recorder in response to the approach of a commercial vehicle.
